(19) United States
(12) Patent Application Publication
(10) Pub. No.: US 2006/0195693 A1
(43) Pub. Date: Aug. 31, 2006

(54) Specter rendering

(75) Inventors: Veeraiyan M. Kandasamy, San Jose, CA (US); Muhamed Aganagic, Mountain View, CA (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 11/067,221

(22) Filed: Feb. 28, 2005

(51) Int. Cl. H04L 9/00

(52) U.S. Cl. 713/166

(57) ABSTRACT

Specters may be used to provide software configurations for specter client computer systems, which may be any type of computer system (client, server, stand-alone, etc.). A specter client computer system may contain sufficient functionality to obtain and launch a specter, which may be stored on a specter rendering system.

### BACKGROUND OF THE INVENTION

A major problem facing computer system owners is the cost of ownership. The cost of ownership includes such expenses as operating, maintaining, and troubleshooting the computer system. These expenses have grown particularly in recent times, for example, with the continuing decline in hardware costs and the advent of internet computing, which may result in increasing numbers of server systems and client systems to be operated and maintained.

Two particular information technology (IT) problems that may increase the cost of performing these tasks are handling of backing up and restoring information stored on various local storage media and software compliance at the various local computer systems. The problem of backing up and storing information may involve determining what information to back up/restore, how to store it so that it may be restored easily and/or flexibly, etc. The problem of software compliance may involve ensuring that all systems are using particular versions of various software, for reasons that may relate to legal issues, troubleshooting, technical support, etc. These problems may relate to issues in terms of, for example, mobility, flexibility, security, management, etc.

### BRIEF DESCRIPTION OF THE DRAWINGS

Various embodiments of the invention will now be described in connection with associated drawings, in which:

FIG. 1 depicts a block diagram of a system according to an exemplary embodiment of the invention;

FIGS. 2A and 2B depict flowcharts of a specific exemplary embodiment of the invention; and

FIG. 3 depicts a flowchart according to a further exemplary embodiment of the invention.

### DETAILED DESCRIPTION OF EMBODIMENTS OF THE INVENTION

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-accessible medium, which may be read and executed by a computing platform to perform the operations described herein. A machine-accessible medium may include any mechanism for storing or transmitting information in a form readable and/or writable by a machine (e.g., a computer). For example, a machine-accessible medium may include read-only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

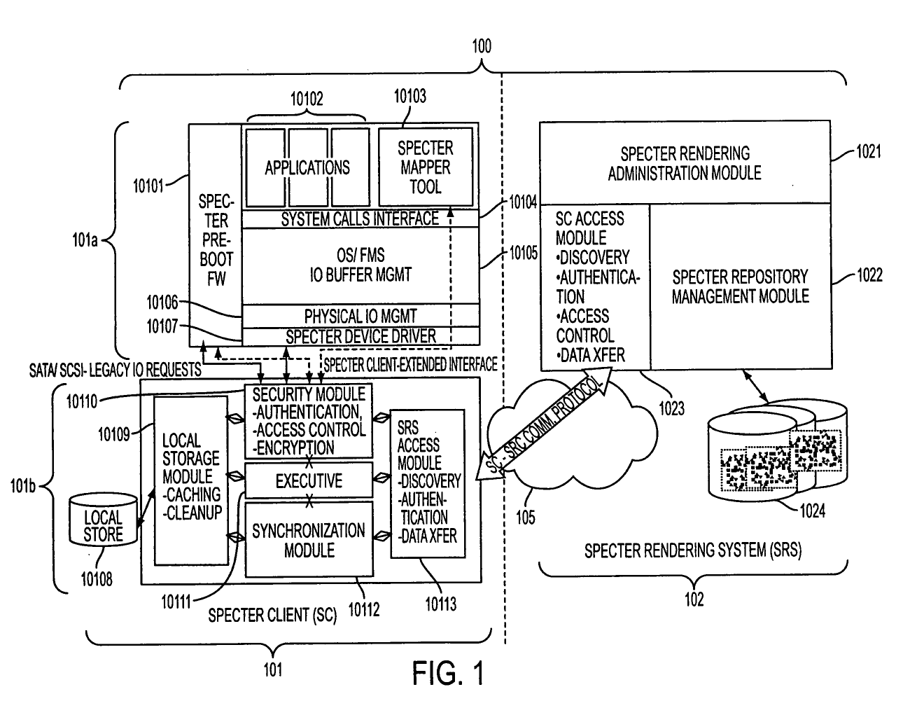

FIG. 1 depicts a block diagram showing an exemplary embodiment of a system according to the invention. FIG. 1 shows a system 100 that may be used for specter rendering. A specter is a software-only characterization of a computer system. System 100 may be divided into two parts: specter client (SC) 101 and specter rendering system (SRS) 102. SC 101 and SRS 102 may be located remotely from each other or may be collocated. SC 101 and SRS 102 may be coupled by means of a network 105, which may be any network or networks supporting communications between computer systems (e.g., local area network (LAN), wide-area network (WAN), wireless network, optical network, the Internet, etc.). As shown in FIG. 1, communication between SC 101 and SRS 102 may use an SC-SRS Communication Protocol that may comprise any appropriate protocol supporting communications over network 105, and which may include additional features unique to communication between an SC 101 and an SRS 102.

SC 101 may be any type of computer system (client, server, stand-alone, etc.), and may be conceived of as comprising two parts: SC disk controller (SCDC) 101b and SC core components (SCCC) 101a. SCDC 101b may provide an interface between SCCC 101a and SRS 102 and/or local storage 10108, which may comprise one or more machine-readable media. The interface functionality provided by SCDC 101b may be similar to that of a disk controller in a computer system, and may include functionalities such as authentication, access control, and management, as well as reading and/or writing of data (from and/or to, for example, but not limited to, virtual disk areas of a specter). SCDC 101b may comprise a local storage module 10109, a security module 10110, an executive module 10111, a synchronization module 10112, and an SRS access module 10113. Local storage module 10109 may be coupled to the one or more machine-readable media of which local storage 10108 may be comprised and may control such functions as caching and cleanup. Security module 10110 may provide an interface between SCCC 101a and SCDC 101b, and it may perform functions such as authentication, access control, and encryption. Executive 10111 may interact with the other components of SCDC 101b to provide control and/or interface functionality. Synchronization module 10112 may perform various synchronization functions. Finally, SRS access module 10113 may function to permit SC 101 to interface with SRS 102 via network 105. SRS access module 10113 may be involved in such functions as discovery (e.g., of the presence of an SC 101), authentication, and data transfer.

To further explain synchronization module 10112, specter images may be resident on SRS 102. However, virtual disk blocks of a specter may be stored on local storage 10108, which may provide, for example, improved flexibility and/or performance. In such a case, synchronization module 10112 may synchronize the specter image on SRS 102 with the virtual disk blocks stored on local storage 10108.

SCCC 101a may comprise specter pre-boot component 10101; one or more applications 10102; specter mapper tool 10103; system calls interface 10104; operating system/file management system (OS/FMS) 10105, which may perform I/O buffer management; physical I/O management component 10106; and specter device driver 10107.

Specter pre-boot component 10101 may provide functionality necessary prior to loading and launching a specter, including functionalities required to perform the operations necessary to load and launch a specter. In some embodiments of the invention, specter pre-boot component 10101 may be implemented in firmware, as shown in FIG. 1, but it is not intended to be limited to such an implementation. Specter pre-boot component 10101 may, for example, comprise a firmware-based or other basic input/output system (BIOS).

The specter mapper tool 10103 may be used by an IT administrator or other authorized user to create and configure a specter. The specter mapper tool 10103 may run as an application above an operating system and may accordingly be capable of observing high-level structures, such as directories, files, and file types. At the same time, it may utilize specter device driver 10107 (to be discussed further below) to help map files and directories to the zone structure of a specter. Consequently, specter mapper tool 10103 may permit the IT administrator or other authorized user to map OS/file system entities (for example, files and/or folders) into zones of the specter and may permit the IT administrator or other authorized user to set appropriate properties for the various zones. For example, the IT administrator or other authorized user may wish to map a boot sector and/or OS binary files to a zone having “read-only” permission for all (or some subset of) end users. In general, using specter mapper tool 10103, zones may be created and/or deleted, access control may be set, and/or synchronization attributes may be set.

Specter device driver 10107 may be a driver implementation that is compliant with host OS 10105 and may permit the OS 10105 to interface with SCDC 101b. Its functionalities may include the functionality of a disk device driver. It may further expose the functionalities of SCDC 101b to permit specter mapper tool 10103 to perform such functions as creating zones, mapping disk blocks to zones, et al. SCCC 101a may also comprise various other interface and/or management components, like 10104 and/or 10106, that may be used in managing various components of the system and/or in providing interfaces between various parts of the system. These components of SCCC 101a, as well as components 10102 and 10105, may be part of a legacy operating system and/or applications. However, they may also be, or include, components that are adapted to take advantage of the use of specters.

It is further noted that specter pre-boot component 10101 may provide a further interface with SCDC 101b, e.g., with security module 10110. For example, various I/O requests (shown in FIG. 1 by the solid arrows between SCCC 101a and SCDC 101b), which may be, but are not limited to, SATA or SCSI I/O requests, may be handled directly between specter pre-boot component 10101 and SCDC 101b, and such direct interfacing may extend beyond the launching of a specter (as indicated by one of the dashed arrows in FIG. 1 between SCCC 101a and SCDC 101b). Furthermore, pre-boot authentication functionality, which may involve security module 10110, may be included in specter pre-boot component 10101 (following authentication, specter pre-boot component 10101 may serve virtual disk blocks of a specter, whose boot sectors may then be loaded and may, in turn, load the operating system and give it control). Similarly, specter mapping tool 10103 may interact with SCDC 101b via the post-boot specter client extended interface (indicated by a dashed arrow between specter mapper tool 10103 and SCDC 101b).

SRS 102 may comprise specter rendering administration module 1021; specter repository management module 1022; SC access module 1023; and one or more machine-accessible media 1024. Specter rendering administration module 1021 may provide, for example, control functionality for SRS 102. Specter repository management module 1022 may be coupled to one or more machine-accessible media 1024. The one or more machine-accessible media 1024 may be used to store and retrieve one or more specters, and specter repository management module 1022 may provide an interface with the one or more machine-accessible media 1024. In some embodiments of the invention, the one or more machine-accessible media 1024 may comprise one or more mass storage devices, such as magnetic disks, optical disks, etc. Finally, SC access module 1023 provides an interface between SRS 102 and SC 101 via network 105 and may perform such functions as discovery, authentication, access control, and/or data transfer.

Using system 100, a specter may be created for at least some of the software components of an SC 101. The specter may be stored by an SRS 102. A specter may be active, e.g., when instantiated on an SC 101, or it may be inactive when stored on SRS 102 and not running anywhere. The specter may later be retrieved from SRS 102 and launched on the same or another SC 101 to instantiate and run the specter. According to an embodiment of the invention, a specter may only be run on a single SC 101 at a given time, and SRS 102 may ensure that this is the case.

Specters may be user-specific and/or machine-specific. Additionally, multiple versions of a specter may be stored, which may provide backup capability and/or the ability for a system to be restored to a previous state, if desired. Such capabilities may be particularly helpful, for example, in the case of a crash at SC 101, permitting SC 101 to be restored to a previous state. Similarly, if the hardware of an SC 101 crashes, the specter may be loaded and launched on a different machine (capable of being an SC).

The system 100 may permit IT staff to control various software components of SCs 101. This may, for example, prevent users not authorized to do so from tampering with various software components, and it may enable the IT staff to seamlessly (to the non-IT user) provide upgrades, patches, etc., to software components.

A further application of system 100 is where SC 101 is a computer that may be used by multiple users. Given that specters may be user-specific, an SC 101 may be loaded with a particular specter when a particular user is using SC 101 and with a different specter when another user is using SC 101. Similarly, this may enable a user to migrate from one SC 101 to another while still being able to use the same (to the extent that it is stored in his specter) software.

As discussed above, a specter may include all or part of the software configuration of a SC 101. What portions of software are included in the specter are determined by means of zones, discussed above, having different read/write privileges. For example, some zones may be designated for read/write access by a given user and for read-only access by IT staff; such zones may be useful in a situation in which a user wishes to designate particular information (software, data, etc.) to be backed up by the IT staff. The user may do so by writing such information into such zones. As another example, zones that permit IT write access may be used to provide, for example, upgrades and/or patches to software in those zones. Furthermore, by using zones, user privacy from IT staff may be maintained for information that a user keeps in zones to which IT staff do not have read or write access. In general, zones having different privilege levels may be used to determine who has control over what data is backed up and restored, and may be extended to provide further flexibility, as well (e.g., certain zones may be designated for backups at different times or with different frequencies).

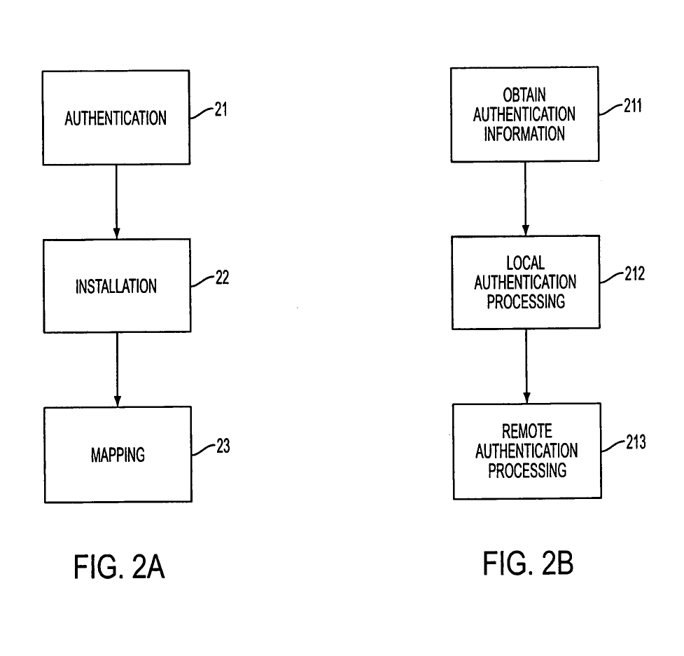

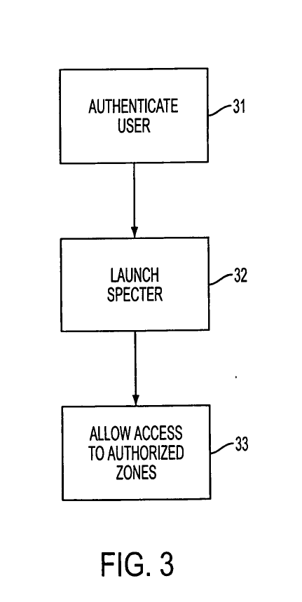

Various aspects of how system 100 may operate according to various embodiments of the invention are illustrated by the flowcharts shown in FIGS. 2A, 2B, and 3.

FIG. 2A depicts a flowchart showing how a specter may be created according to an embodiment of the invention. A specter may, according to embodiments of the invention, be created by an IT administrator or other authorized user. This may be done on any specter-enabled computer (i.e., on any SC). The IT administrator or other authorized user may provide authentication information to the specter pre-boot component 10101. Authentication 21 and initiation of specter creation may then be performed in conjunction with SCDC 101b. Authentication 21 may be implemented as shown in the flowchart of FIG. 2B. As shown in FIG. 2B, authentication information may first be obtained 211, as previously discussed. Then, local authentication processing may be performed 212 at the SC, also as previously discussed. Authentication 21 may include communication between SCDC 101b, via network 105, and SRS 102, which may enable completion of authentication and authorization by performing remote authentication processing 213 at the SRS 102. The IT administrator or authorized user may then install the OS and/or applications, as indicated by Block 22. At this point, the entire specter may consist of a single zone with all access only to the creator (i.e., the IT administrator or other authorized user). The creator may then use specter mapping tool 10103 to divide the specter into multiple zones with various access privileges, as indicated by Block 23. After the specter has been created, the specter may then be considered to be “alive,” and its master image may be stored on an SRS 102. This may be ensured by synchronization module 10112, which may perform synchronization transfer interfacing with local storage module 10109 and SRS access module 10113.

FIG. 3 depicts a flowchart of how specters may be used, after they have been created, according to an embodiment of the invention. A user may start up any specter-enabled computer (i.e., any SC). The specter pre-boot component 10101 may accept user credentials and may perform authentication 31, which may again be in conjunction with (one or more components of) SCDC 101b and/or SRS 102. Following authentication, specter pre-boot component 10101 may accept user input to identify the desired specter to be instantiated and may make a corresponding request to SCDC 101b. If authentication is successful (which may, again, be performed in conjunction with SRS 102), the specter may be loaded from SRS 102 and launched 32. Following launch of the specter, SCDC 101b may allow access to authorized zones by the user 33. In particular, SCDC 101b may accept read and write I/O requests, may recognize the zone targeted by each such request, and may perform access control for each request.

The synchronization module 10112 may ensure that the specter image on SRS 102 and the current instantiation are in synch. For example, an IT administrator may launch a specter on an SC 101 and may perform such privileged operations as updating the operating system, applying patches, installing applications, etc., and may even make changes to the zone mapping using specter mapper tool 10103. The resulting updated specter may be synchronized with the master image on SRS 102. Later on, when a (non-privileged) user launches the same specter on that user's SC 101, the updated specter may be synchronized with the local store module 10108.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. An apparatus, comprising:
a computer system including at least one processor and memory, said computer system comprising:
a specter pre-boot component to manage said computer system prior to the presence of a specter; and
a specter client disk controller, to communicate with said specter pre-boot component and to interface with at least one of the group consisting of: a facility to store a specter, a facility to retrieve a specter, and a facility to store and retrieve a specter.

2. The apparatus according to claim 1, wherein said specter pre-boot component comprises firmware.

3. The apparatus according to claim 1, wherein said specter client disk controller comprises:
a security module to engage in at least one operation selected from the group consisting of authentication, access control, and encryption; and
an interface module to provide an interface with said at least one facility to perform at least one operation selected from the group consisting of discovery, authentication, and data transfer.

4. The apparatus according to claim 1, said computer system further comprising:
a specter mapping tool to permit an authorized user to create one or more access zones in a specter.

5. The apparatus according to claim 1, said computer system further comprising:
a synchronization module to synchronize an instantiation of a specter on said computer system with a stored version of said specter.

6. An apparatus, comprising:
a computer system including at least one processor and memory, said computer system comprising:
an interface module to communicate with at least one specter client to store or retrieve at least one specter from a facility associated with said computer system and comprising at least one of the group consisting of: a facility to store a specter, a facility to retrieve a specter, and a facility to store and retrieve a specter; and
a storage management module coupled to said interface module and to said storage or retrieval facility to control storage or retrieval of at least one specter;
said facility comprising at least one machine-accessible medium to perform one of the group consisting of: storing at least one specter, retrieving at least one specter, and storing and retrieving at least one specter.

7. The apparatus according to claim 6, wherein said interface module engages in at least one operation selected from the group consisting of: discovery, authentication, access control, and data transfer.

8. The apparatus according to claim 6, further comprising:
an administration module coupled to said interface module and to said storage management module to provide control functionality to facilitate at least one of the group consisting of: storage of at least one specter, retrieval of at least one specter, and storage and retrieval of at least one specter.

9. A system, comprising:
a specter rendering system comprising a computer system that includes at least one processor and memory, the specter rendering system comprising:
an interface module to communicate with at least one specter client to store or retrieve at least one specter from a facility associated with said computer system and comprising at least one of the group consisting of: a facility to store a specter, a facility to retrieve a specter, and a facility to store and retrieve a specter; and
a storage management module coupled to said interface module and to said facility to control at least one of the group consisting of: storage of at least one specter, retrieval of at least one specter, and storage and retrieval of at least one specter;
said facility comprising at least one machine-accessible medium to perform one of the group consisting of: storing at least one specter, retrieving at least one specter, and storing and retrieving at least one specter; and
at least one specter client to communicate with said specter rendering system to perform one of the group consisting of: storing at least one specter, retrieving at least one specter, and storing and retrieving at least one specter; the specter client comprising a computer system that includes at least one processor and memory, the specter client comprising:
a specter pre-boot component to manage said specter client prior to the presence of a specter; and
a specter client disk controller, to communicate with said specter pre-boot component and to interface with said specter rendering system.

10. The system according to claim 9, wherein said specter rendering system and said at least one client are coupled to each other via at least one communication network.

11. The system according to claim 9, wherein said specter rendering system and said at least one client work together to perform authentication.

12. The system according to claim 9, said specter client further comprising:
a synchronization module to synchronize an instantiation of a specter on said specter client with a version of said specter stored on said specter rendering system.

13. A method comprising:
authenticating a user;
creating a specter, including installing software; and
mapping said specter into zones having associated access privileges.

14. The method according to claim 13, wherein said authenticating comprises:
obtaining authentication information from said user;
performing local authentication processing based on said authentication information; and
performing remote authentication processing in cooperation with a specter rendering system.

15. The method according to claim 13, further comprising:
storing said specter in a specter rendering system.

16. The method according to claim 13, wherein said specter includes at least one of the group consisting of: application software and operating system components.

17. A machine-accessible medium containing instructions that, when executed by a processor, cause said processor to execute a method comprising:
authenticating a user;
creating a specter, including installing software; and
mapping said specter into zones having associated access privileges.

18. The machine-accessible medium according to claim 17, wherein said authenticating comprises:
obtaining authentication information from said user;
performing local authentication processing based on said authentication information; and
performing remote authentication processing in cooperation with a specter rendering system.

19. The machine-accessible medium according to claim 17, further containing instructions that, when executed by a processor, cause said processor to further execute operations comprising:
storing said specter in a specter rendering system.

20. A method comprising:
authenticating a user;
obtaining a specter from a specter rendering system;
launching said specter; and
permitting said user to access zones of said specter for which said user has access privileges.

21. The method according to claim 20, wherein said authenticating comprises:
obtaining authentication information from said user;
performing local authentication processing based on said authentication information; and
performing remote authentication processing in cooperation with said specter rendering system.

22. The method according to claim 20, wherein at least one zone for which said user has access privileges is a zone where said user has at least read/write privileges and where a second user has fewer access privileges.

23. The method according to claim 20, wherein at least one zone for which said user has access privileges is a zone where said user has a fewer access privileges than a second user having at least read/write privileges.

24. The method according to claim 20, wherein said method is executed on a computing platform different from a computing platform used to create said specter.

25. The method according to claim 20, further comprising:
synchronizing an instance of said specter resulting from said launching with a version of said specter stored on said specter rendering system.

26. A machine-accessible medium containing instructions that, when executed by a processor, cause said processor to execute a method comprising:
authenticating a user;
obtaining a specter from a specter rendering system;
launching said specter; and
permitting said user to access zones of said specter for which said user has access privileges.

27. The machine-accessible medium according to claim 26, wherein said authenticating comprises:
obtaining authentication information from said user;
performing local authentication processing based on said authentication information; and
performing remote authentication processing in cooperation with a specter rendering system.

28. The machine-accessible medium according to claim 26, wherein at least one zone for which said user has access privileges is a zone where said user has at least read/write privileges and where a second user has fewer access privileges.

29. The machine-accessible medium according to claim 26, wherein at least one zone for which said user has access privileges is a zone where said user has fewer access privileges than a second user having at least read/write privileges.

30. The machine-accessible medium according to claim 26, further containing instructions that, when executed by a processor, cause said processor to execute a method further comprising:
synchronizing an instance of said specter resulting from said launching with a version of said specter stored on said specter rendering system.
